(19) United States
(12) Patent Application Publication
(10) Pub. No.: US 2024/0300020 A1
(43) Pub. Date: Sep. 12, 2024

(54) REAL-TIME CONTROL OF LASER POWER FOR LASER POWDER BED FUSION

(71) Applicant: VIRGINIA TECH INTELLECTUAL PROPERTIES, INC., Blacksburg, VA (US)

(72) Inventors: Rongxuan WANG, Blacksburg, VA (US); Benjamin STANDFIELD, Blacksburg, VA (US); Zhenyu KONG, Blacksburg, VA (US); Chaoran DOU, Blacksburg, VA (US)

(21) Appl. No.: 18/601,199

(22) Filed: Mar. 11, 2024

Related U.S. Application Data
(60) Provisional application No. 63/451,419, filed on Mar. 10, 2023.

(51) Int. Cl. B22F 10/36; B22F 12/90; B33Y 50/02

(52) U.S. Cl. CPC B22F 10/36; B22F 12/90; B33Y 50/02; B22F 2203/03

(57) ABSTRACT

An example feedback control system includes a laser powder bed fusion (L-PBF) platform including a laser. The L-BPF platform is configured to print a target object with the laser. The feedback control system includes a sensing system configured to measure an operative thermal emission index (TEI) emitted during print of the target object by the L-PBF platform. The feedback control system additionally includes a controller communicatively coupled to the sensing system. The feedback control signal is configured to determine an error based on a comparison between a control setpoint and the operative TEI, generate a control signal based on the error, and adaptively adjust a power of the laser during the print of the target object based on the control signal to maintain the control setpoint.

### CROSS-REFERENCE TO RELATED APPLICATION

This application claims the benefit of and priority to U.S. Provisional Patent Application No. 63/451,419, filed Mar. 10, 2023, entitled “REAL-TIME PROCESS MONITORING AND CLOSED-LOOP CONTROL ON LASER POWER VIA A CUSTOMIZED LASER POWDER BED FUSION PLATFORM,” the contents of which is hereby incorporated herein by reference in its entirety.

### STATEMENT REGARDING FEDERALLY SPONSORED RESEARCH OR DEVELOPMENT

This invention was made with government support under grant number N00014-18-1-2794, awarded by the Office of Naval Research. The government has certain rights in the invention.

### BACKGROUND

Additive manufacturing (AM) is an effective way to fabricate parts with complex geometries using various materials. For example, additive manufacturing may include fused deposition modeling (FDM), stereolithography (SLA), laser powder bed fusion (L-PBF), among others. Despite the popularity and advancements in AM, AM faces challenges such as achieving high surface quality, dimensional accuracy, and/or minimization of defects. L-PBF may be the preferred AM method in fabricating metal parts.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 depicts a system for feedback control of laser powder bed fusion (L-PBF), according to one or more embodiments of the present disclosure.

FIG. 2 depicts a circuit diagram of a sensing system, according to one or more embodiments of the present disclosure.

FIG. 3 depicts a schematic of a system for feedback control of laser powder bed fusion (L-PBF), according to one or more embodiments of the present disclosure.

FIG. 4 depicts a feedback control algorithm, according to one or more embodiments of the present disclosure.

FIG. 5 depicts a method for implementing a feedback control algorithm, according to one or more embodiments of the present disclosure.

FIG. 6 depicts exemplary lines printed for a control setpoint determination, according to one or more embodiments of the present disclosure.

FIG. 7 is a chart showing correlation between the average dimensional error and the average TEI measured for the control setpoint determination, according to one or more embodiments of the present disclosure.

FIG. 8A depicts a method for implementing a monitoring program, according to one or more embodiments of the present disclosure.

FIG. 8B depicts a method for implementing a data collection algorithm, according to one or more embodiments of the present disclosure.

FIG. 9 depicts another method for implementing a feedback control algorithm, according to one or more embodiments of the present disclosure.

### DETAILED DESCRIPTION

The popularity of additive manufacturing (AM) has increased dramatically in the past decade due to advantages such as being able to effectively fabricate parts with complex geometry. Among AM processes, laser powder bed fusion (L-PBF) has been studied extensively as it is ideal for metal 3D printing. For example, L-PBF may form the part geometry using a high energy density laser beam to selectively melt metal powder onto a substrate. This technology is used in many industries such as aviation, medical, and military. However, L-PBF is hindered by a large number of process parameters and non-steady state printing, making high-quality printing may be difficult to achieve. For example, L-PBF process parameters may include hatch spacing, hatch pattern, hatch angle, layer height, powder size, laser spot size, laser power, laser speed, delay time, protection gas flow rate, among others. For example, the non-steady state printing may be caused by the variation of powder packing, re-melting, heat accumulation, spatters, un-uniform powder spreading, and other reasons.

L-PBF generally fabricates parts layer by layer, and each layer may be filled by melt tracks. Raster, a tool path generation strategy associated with filling area by parallel lines, is the most common scanning pattern in L-PBF. However, using a fixed laser power regardless of raster length and printing feature size (thin wall or pointy regions less than 400 μm are commonly referred to as small features in L-PBF) may cause various quality issues. For example, miniature features or sharp corners may have short raster lines. In this scenario, heat may accumulate and cause over-melt. The root cause of heat accumulation may be the insufficient cooling time of the previous melt path when the laser melts the adjacent area again. When this problem occurs, shape accuracy cannot be ensured. In addition, over-melt may cause microstructure inconsistency resulting from inconsistent cooling rates and thermal gradients. A severe porosity may occur since the melt pool may have a strong keyhole. In contrast, large features may have long raster lines and less heat accumulation. If laser power is low, favoring small feature printing quality, an insufficient melt may occur on large features. Such phenomenon may cause defects such as high surface roughness, balling, and/or lack of fusion.

Therefore, one or more embodiments of the present disclosure are directed toward overcoming at least some of the problems discussed above. One or more embodiments are configured to control laser power of a L-PBF platform with a feedback control method, to adaptively regulate laser power based on thermal emission measurements received in real-time during operation of a print process. One or more embodiments may include a closed-loop control system to regulate laser power based on melt pool thermal emission to avoid over-melt, balling, high surface roughness, among others. The feedback control method and closed-loop control system may include determining a control target by correlating printing quality (e.g., dimensional printing error) with thermal emission measurements based on thin-line printing trials using variable power. One or more embodiments may include a high-speed thermal sensor and controller that may be used for the feedback control method and the closed-loop control system. One or more embodiments may successfully maintain a low dimensional error by regulating laser power at 2 kHz.

One or more embodiments may provide significant improvement in printing quality based on adaptively adjusting the power of the laser in real-time during the print process resulting in lower dimensional errors for the target object being printed as compared to the target object being printed with a fixed power level of the laser.

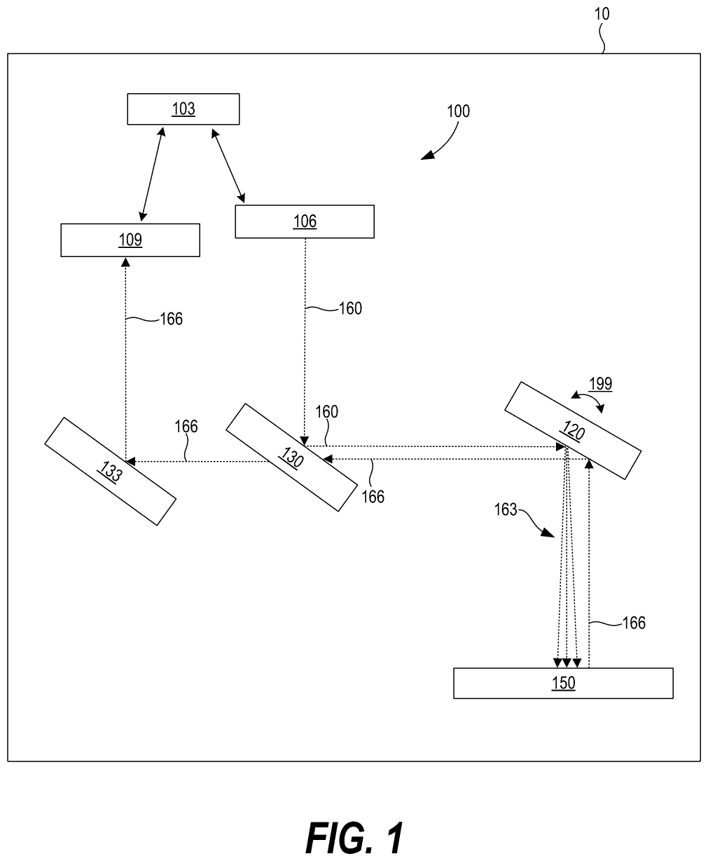

Referring now to the drawings, FIG. 1 depicts a system 100 for feedback control of a laser powder bed fusion (L-PBF) tool 10, according to one or more embodiments of the present disclosure. The system 100 includes a controller 103, a laser 106, a sensing system 109, a galvanometer 120, a first mirror 130 (e.g., dichroic beam splitter), a second mirror 133, and a powder bed 150 as depicted. The L-PBF tool 10 may be used to print a target object on the powder bed 150 and simultaneously control a power of the laser 106 in real-time (or near real-time) to effectively minimize any resulting dimensional errors that may arise during the print process. The L-PBF tool 10 and the components of the L-PBF tool 10 are representative in FIG. 1. One or more of the components of the L-PBF tool 10 can be omitted in some cases. One or more additional components that are not illustrated in FIG. 1 can be added to the L-PBF tool 10. It should also be appreciated that the depiction in FIG. 1 is not exhaustive, as some components have been omitted from view for simplicity. The arrangement of the components can also vary as compared to that shown. For example, the controller 103, the sensing system 109, and other components can be separated or separate from the remainder of the L-PBF tool 10 in some cases, while being communicatively coupled to the L-PBF tool 10.

The controller 103, the sensing system 109, the laser 106, and the powder bed 150 may be communicatively coupled to each other. The first mirror 130 and the second mirror 133 may each function as a beam splitter to redirect light signals emanating from the laser 106 or reflected from the powder bed 150. For example, the first mirror 130 may be configured to reflect light signals corresponding to the laser spectrum and enable pass-through of light signals corresponding to the visible light spectrum. In contrast, the second mirror 133 may be configured to reflect light signals corresponding to the visible light spectrum. The galvanometer 120 may include one or more mirrors and may also function as a beam splitter. The galvanometer 120 may be adjustable (e.g., tilted or swiveled) in a direction represented by arrows 199. Additionally, the galvanometer 120 may be configured to reflect light signals corresponding to the laser spectrum and light signals corresponding to the visible light spectrum. The first mirror 130, the second mirror 133, and/or the galvanometer 120 may be tilted at approximately a 45° angle with respect to a horizontal axis but may be configured to have different tilt angles. The L-PBF tool 10 may be implemented with a coaxial system implementation, according to one or more embodiments.

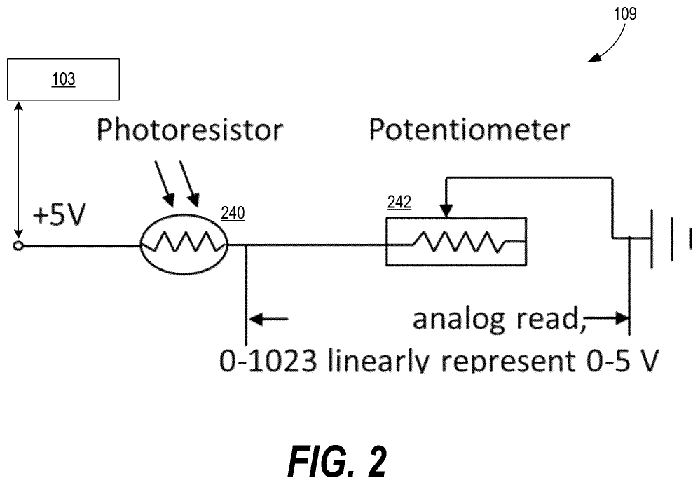

The sensing system 109 is configured to detect emissions, such as light, heat, or a combination of heat and light emissions emanating from the powder bed 150 during laser printing. The sensing system 109 may include a photodetector and a variable resistor in one example and may be configured to detect the thermal emission from heat. Reference is made to FIG. 2, which depicts a circuit diagram of the sensing system 109, according to one or more embodiments of the present disclosure. For example, a photodetector 240 of the sensing system 109 may be a light-dependent resistor (photoresistor or LDR) that may change its resistance depending on the number of photons it receives. In other cases, the photodetector 240 can be embodied as a photodiode or other device having an electrical characteristic that varies based on the detection of photons. The photodetector 240 may be an analog LDR having no sensing frequency constraints. A variable resistor 242 of the sensing system 109 may be a potentiometer serially connected to the photodetector 240. The sensing system 109 may be powered by a power supply from the controller 103 or any other power supply. The controller 103 may use an analog-read pin to read (i.e., measure) the voltage across the variable resistor 242 as an input. Since the resistance of the photodetector 240 may drop with increasing detection of photons or greater laser light intensity or power, the voltage drop across the variable resistor 242 may increase when the melt pool and surrounding temperature at the powder bed 150 rises during a print process by the L-PBF tool 10. As such, the sensing system 109 may function as a pyrometer. The sensing system 109 is a low-cost thermal emission sensor, according to one or more embodiments.

For L-PBF, heavy data smoothing may be needed since lasers (e.g., the laser 106) often switch on and off frequently during printing and sparks may appear randomly. The response time of the photodetector 240 may serve as a moving average type of data smoother. The insensitive spectrum characteristics of the photodetector 240 may not significantly influence the measuring capability of the photodetector 240 since the melting temperature of most metal materials used for 3D printing may generate a significant amount of visible light.

The variable resistor 242 offers a sensitivity range adjustment for the photodetector 240. For example, even though analog signals generated by the photodetector 240 may have infinite resolution, the controller 103 may only provide 2¹⁰=1024 different readings when running on a 10 bit format. In particular, an analog read function may generate integers from 0 to 1023, representing 0-5 V voltage linearly and enabling corresponding measurements to have finite resolution. To achieve smooth control, the sensing system 109 may need to cover as many integers as possible.

For example, when the resistance of the variable resistor 242 is significantly higher than the resistance of the photodetector 240, the response of the sensing system 109 may be 1023 (representing 5 V). However, a change in the resistance of the photodetector 240 due to different printing temperatures cannot influence the voltage on the variable resistor 242, making the reading difficult to distinguish between different printing conditions. To the contrary, when the variable resistor 242 has a very small resistance compared to that of the photodetector 240, regardless of thermal emission changes originating from the powder bed 150, the photodetector 240 may drop most of the voltage and cause the voltage reading of the photodetector 240 to be close to zero, which may create difficulty in distinguishing different printing conditions. Therefore, the resistance of the variable resistor 242 can be tuned appropriately depending on a measured temperature range.

To optimize the sensing system 109, a term denoted resolution of interest (ROI) is defined as the number of distinguishable values between a minimum and a maximum printing temperature associated with the laser 106. Based on certain experiments, heat accumulation is likely to occur when raster lines are shorter than 2 mm. The minimum printing temperature may be defined as when minimum laser power (e.g., 100 W) is used to print a non-heat accumulation pattern (e.g., a rectangular shape including 2.5 mm raster lines). To the contrary, the maximum printing temperature may be set as the temperature when heat accumulation occurs intensively (e.g., printing a miniature feature with 200 W of laser power).

Tuning the sensing system 109 may be achieved by adjusting the variable resistor 242. For example, an ambient light condition may be used to determine a setting of the sensing system 109 based on a thermal emission index (TEI) measurement. In addition, resulting TEI measurements from using the minimum and maximum laser powers of the laser 106 may also be used to tune the sensing system 109. For example, sample TEI measurement patterns corresponding to an ambient, insufficient melt, over-melt, and cooling scenarios, as measured by the sensing system 109, may be analyzed to determine a corresponding ROI and used to tune the variable resistor 242 to optimize the sensing system 109.

The following provides various non-limiting examples or exemplary applications of the components of the system 100. The laser 106 may include various lasers compatible with L-PBF. In one example, the laser 106 may be a Raycus RFL-C1000. The galvanometer 120 may be mounted on a vertical stage to adjust laser focus and spot size. A head of the laser 106, the galvanometer 120, and associated optics may be cooled by a water chiller. An adjustable aluminum pipe may be installed between the powder bed 150 and the galvanometer 120. The powder bed 150 may include a powder bed fixture, a powder dispenser, a powder spreader, a piston-cylinder design powder bed, and/or a substrate. The powder dispenser may be configured to deposit a gentle amount of powder, and the powder spreader may be configured to spread the powder uniformly on the substrate. The powder amount, spread speed, and layer heights may be adjustable via the controller 103.

In an example, the piston-cylinder design powder bed may be actuated by a high-precision (0.9 μm) linear stage (e.g., Newport® linear stage). A printing area for the powder bed 150 may be 25.4 by 25.3 mm² for powder-saving purposes but can be easily upgraded to a larger size. In an example, the printing height may be 25 mm but may be determined by the maximum travel distance of the piston stage. The controller 103 may drive the powder spreader and the powder dispenser. The controller 103 may further control the linear stage.

The controller 103 may include one or more controllers and may be configured to control a print process of a target object on the powder bed 150. Additionally, the controller 103 may be configured to control various operations of the sensing system 109 and the laser 106 using a feedback control system to adaptively control a power of the laser 106 during the print process to minimize dimensional errors.

The controller 103 can be embodied by any suitable control system, including one or more processors, processing circuits, and memory devices. The controller 103 can be directed, in part, by the execution of software or computer-readable instructions stored on a memory device. Among other operations, the controller 103 may be configured to control the laser 106 and the sensing system 109, to control a print process of a target object on the powder bed 150. For example, a print process of a target object may include printing of various metal parts such as aerospace components, medical implants, automotive parts, tooling components, defense and military applications, and other metal parts. The controller 103 can be embodied as an integrated or embedded control system in some cases. The controller 103 can be embodied as an Arduino® based controller in one example, although other types of controllers can be relied upon.

The controller 103 can be directed by a three-dimensional (3D) computer-aided design model (e.g., a CAD file) representative of the shape and size of the target object being formed. One example of such a CAD file may be a standard triangle language or a standard tessellation language (STL) file, which is a file type commonly used in 3D printing. An STL file represents a 3D model, which can be sliced into many layers by the controller 103 to be 3D printed by the laser 106. The CAD file can be created or drawn separately using any suitable CAD applications or tools and loaded into the controller 103 via a computer network, removable media drive, or other suitable way.

The controller 103 may include or implement a proportional-integral-derivative (PID) controller as part of a feedback control system. The feedback control system may be implemented for a print process of a target object, as discussed above. The feedback control system may be operative during a print process based on operative TEI measurements received by the sensing system 109. For example, based on the operative TEI measurements received by the sensing system 109 and in comparison to a control setpoint, the controller 103 may be configured to adaptively regulate a power of the laser 106 for the print of the target object. A description of how the operative TEI measurements are received by the sensing system 109 is provided below in association with print of a target object.

Based on signals received from the controller 103, the laser 106 may be configured to print a target object on the powder bed 150. For example, the laser 106 may emit a light signal (e.g., laser signal) 160 which may be received and reflected by the first mirror 130. For example, the first mirror 130 may be configured to reflect a laser spectrum (e.g., 1070 nm), which may cause the light signal 160 to reflect to the galvanometer 120. The galvanometer 120 may be configured to direct, split, or direct and split the light signal 160 into multiple beams 163 and direct the multiple beams 163 to the powder bed 150. The multiple beams 163 may be used to melt or sinter powder particles on the substrate of the powder bed 150 for printing of the target object.

The melting or sintering of the particles on the powder bed 150 during the printing process may generate a resultant light signal 166 including energy. The resultant light signal 166 may be of a different light spectrum than that of the light signal 160. For example, the resultant light signal 166 may possess a visible light spectrum ranging from approximately 400 nm to approximately 700 nm. The resultant light signal 166 may travel to the galvanometer 120 and reflect off the galvanometer 120 to the first mirror 130. As the first mirror may be configured to allow light signals corresponding to the visible light spectrum to pass through, the resultant light signal 166 may pass through the first mirror 130 and travel to the second mirror 133. The second mirror 133, which may be configured to reflect light signals corresponding to the visible light spectrum, may reflect the resultant light signal 166 to the sensing system 109.

The sensing system 109 may be configured to determine or measure an operative TEI occurring from the print process based on receipt of the resultant light signal 166. The operative TEI may correspond to thermal emission (e.g., heat) originating from the powder bed 150 during the print process. For example, the heat originating from the powder bed 150 may be variable during the print process depending on complexity of the target object being printed, printing feature size, power of the laser 106 being used (e.g., 100 W, 200 W, 300 W, 400 W, etc.), and length of raster lines, among others. The resultant light signal 166 may correspond to the heat originating from the powder bed 150 during the print process, and the sensing system 109 may use the resultant light signal 166 to determine the operative TEI measurement. The TEI measurement may be denoted in TEI units. For example, the temperature of interest as the range between insufficient melt and over melt may correspond to 490-700 TEI units with a 300 ambient TEI units setup. Thus, a resulting signal-to-noise ratio may range from 490 to 700 in some examples.

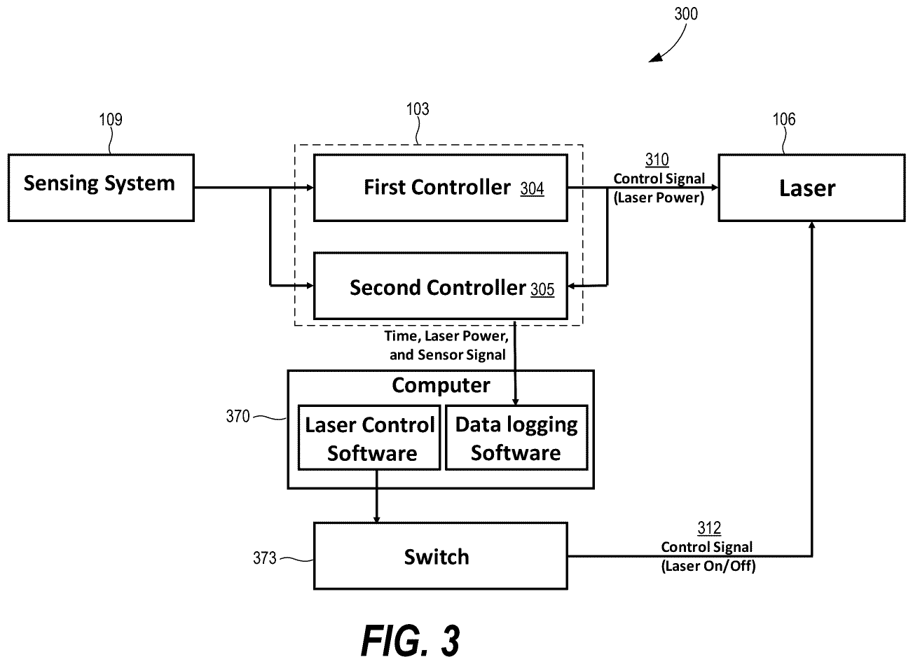

FIG. 3 depicts a schematic of a system 300 for feedback control of L-PBF according to one or more embodiments of the present disclosure. The system 300 may be compatible with the system 100 in implementing feedback control of the L-PBF tool 10, for example, among other platforms and may include many of the same components as the system 100. The system 300 may include the sensing system 109, the controller 103, the laser 106, a computer 370, and a power switch 373 for switching the laser 106 on or off.

As described with respect to the system 100, the sensing system 109 may be configured to determine operative TEI measurements during a print process of a target object based on melting or sintering of particles on the powder bed 150. Based on real-time TEI measurements during a print process of a target object for the system 300, the controller 103 may be configured to adaptively control a power of the laser 106 according to a feedback control algorithm. The controller 103 may include a first controller 304 for executing the feedback control algorithm and a second controller 305 for executing data acquisition operations for logging laser power and thermal emission data. The second controller 305 may be implemented independently to not influence the speed of the feedback control algorithm that may be executed from the first controller. However, the second controller 305 may be omitted in practice in some cases although shown, and the first controller 304 may be used to implement both the feedback control algorithm and data acquisition operations in some examples.

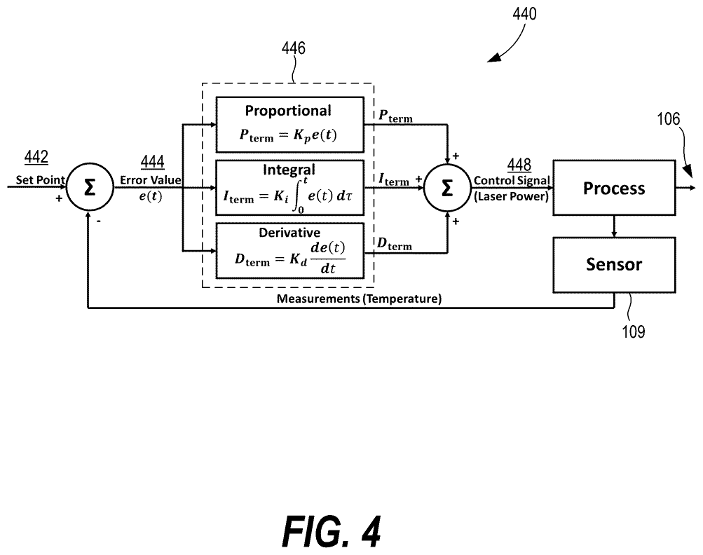

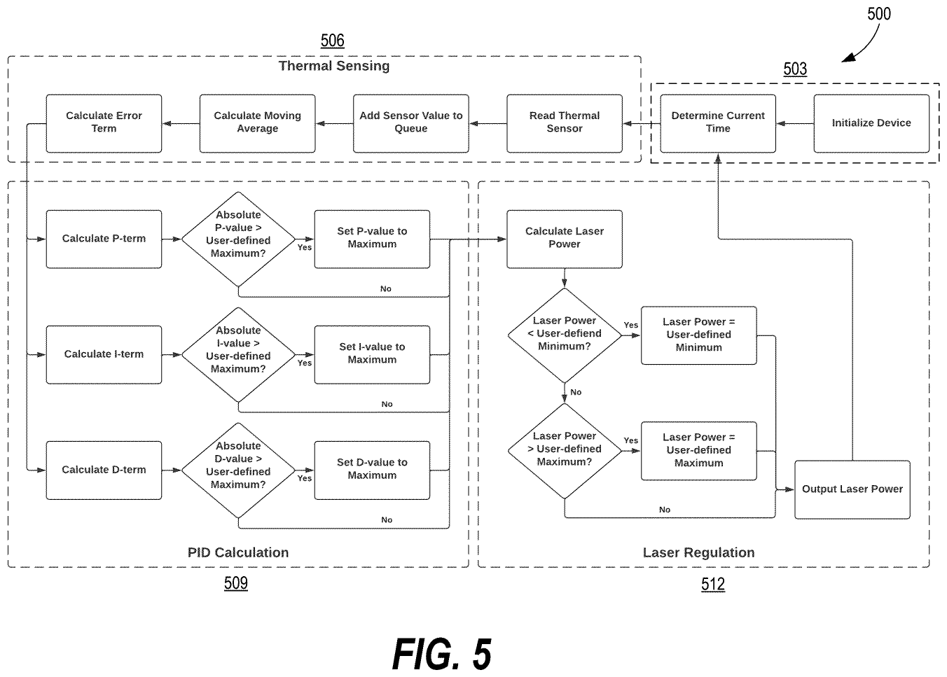

Based on execution of the feedback control algorithm, a control signal 310 may be generated. The laser 106 may be configured to receive the control signal 310 and adjust power levels (e.g., ranging from a user-defined minimum power to maximum power) accordingly. For example, based on receipt of the control signal 310, which may be variable based on a determined error between a control setpoint and operative TEI measurements, the laser 106 may output light signals (e.g., laser signals) of variable power during the print process of the target object. A more detailed description of the feedback control algorithm is provided with respect to FIGS. 4 and 5.

The computer 370 may store laser control software and data logging software in one or more memories. The computer may use the laser control software to process CAD files and start the print process of the target object. The computer 370 may further use the laser control software to end the print process and switch the laser machine 106 on or off via the power switch 373. For example, the power switch 373 may be configured to generate a control signal 312 to switch the laser 106 on or off. The computer 370 may use the data logging software to store the laser power data and the thermal emission data transmitted by and received from the second controller 305.

FIG. 4 depicts a feedback control algorithm 440, according to one or more embodiments of the present disclosure. The feedback control algorithm 440 may correspond to a closed-loop control algorithm such as a PID algorithm that may be implemented in the system 100 and the system 300. The controller 103 may be configured to implement the feedback control algorithm 440. In particular, the first controller 304 may be configured to implement and execute the feedback control algorithm 440. The first controller 304 may be configured to implement the feedback control algorithm 440 based on the operative TEI measurements received from and sent by the sensing system 109. For example, in a PID control loop as provided by the feedback control algorithm 440, the sensing system 109 may be configured to periodically send back the operative TEI measurements back to the first controller 304. The operative TEI measurements may be compared to a control setpoint (e.g., setpoint target) 442 to estimate an error value e(t) 444. The error value 444 may then be processed by proportional (P), integral (I), and derivative (D) calculations 446 to generate a control signal 448 and adjust the process parameters for the laser 106. Individual gains, namely, Kₚ, Kᵢ, and Kₐ, can scale the result of the P, I, and D terms by tuning. According to various aspects of the embodiments, the control signal 448 may correspond to a 1-5 V signal, linearly representing 100-500 W of laser power. However, depending on the specifications of the laser 106 being used, the voltage and power represented by the control signal 448 may vary.

Some challenges of high-speed and real-time control of L-PBF systems may stem from two aspects, such as the speed and lag of the corresponding control system. Speed may refer to the time taken for measurements and related control computations, and lag may refer to the inter-device communication time. For example, a high-speed camera may achieve high time frequency but may have to store the data in a buffer before the data can be transferred to a computer. Such devices may be fast but may have a long lag. The sensing system 109 may circumvent the above-mentioned problems since the photodetector 240 is an analog sensor which does not have intrinsic sensing frequency limitations. Additionally, the feedback control algorithm 440 and associated control decisions may be computationally efficient. For example, low lag may be achieved completing the entire control loop without serial port communication. For example, the sensing and control programs may be run on a dedicated Arduino®, independent of a computer, which may significantly reduce the time needed for inter-device communication (e.g., sensor-computer and computer-controller, etc.) and eliminate the need for a buffer.

The control setpoint 442 may be determined based on a correlation between average dimensional error for the print of the target object and measured TEI. The TEI that corresponds to the smallest dimensional error may be set as the target TEI and also set as the control setpoint 442. The target TEI may be determined by a set of thin line experiments containing six 0.3 mm×8 mm thin lines printed with different laser powers (100 W to 200 W with 20 W increases). For each experiment, the average dimensional error and average TEI may be calculated. Thin line shapes may be chosen because they may be appropriate representations of small features and instantly accumulate heat. These lines may be filled by one-directional raster lines with 55 μm hatch spacing. The powder and substrates may both be made of Ti-64, and the powder size may range from 15-53 μm (e.g., Carpenter Additive®, USA). The laser spot size, speed, and layer height may correspond to 70 μm (1/e² diameter), 800 mm/s, and 30 μm, respectively. Additionally, a flat nozzle may be used for blowing Argon gas at a 20 L/min flow rate above the printing surface to improve the printing quality.

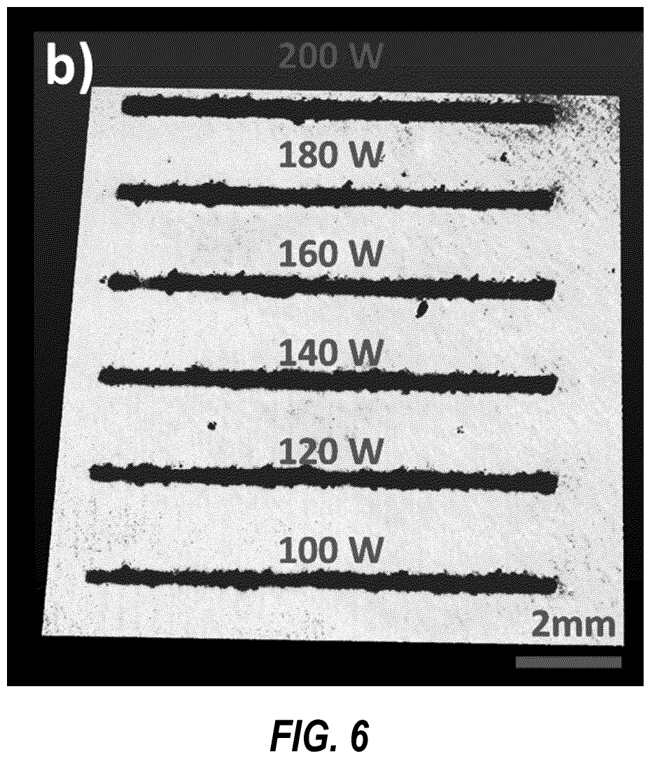

The printed lines corresponding to the above-described experiments are shown in FIG. 6. FIG. 6 depicts exemplary lines printed for a control setpoint determination, according to one or more embodiments of the present disclosure. For each line printed, a width increase may be observed from lines printed with a lower power to lines printed with a higher power. This may result from melt pool size increases. The thin lines that are printed may be scanned by an in-house-built high-performance 3D scanner with 5 μm spatial resolution and 0.055 μm accuracy. A point cloud comparison method may be adopted to calculate the average dimensional error for one or more of the printed lines in FIG. 6, which is the averaged point to mesh distance between the 3D-scanned point cloud data and the CAD model (0.3 mm (W)×8 mm (L)×0.03 mm (T)).

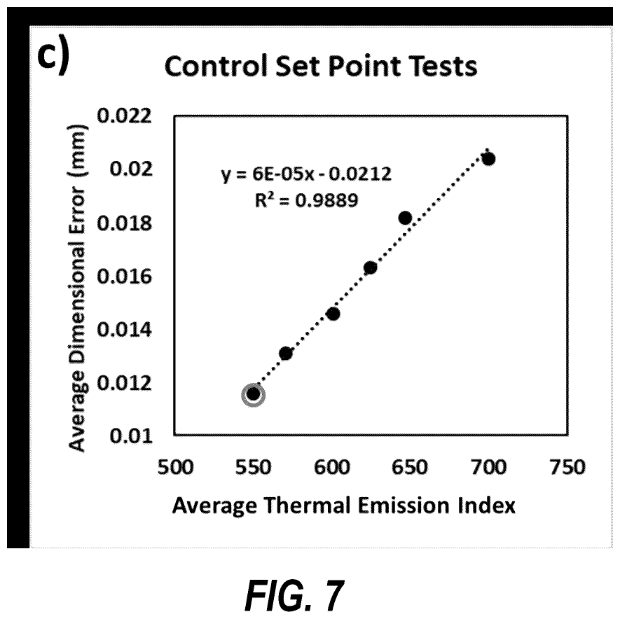

FIG. 7 is a chart showing correlation between the average dimensional error and the average TEI measured for the control setpoint determination, according to one or more embodiments of the present disclosure. The chart shows that the average geometry error linearly correlates with the measured TEI, and that the error is minimal when the sensing system 109 yields 550 TEI units, according to an example. Thus, 550 TEI units may be used as the control setpoint 442. This TEI may correspond to the line printed with 100 W, as shown in FIG. 6. It should be noted, however, that the control setpoint 442 may change depending on properties of the components of the systems 100 and 300 and based on user preferences. For example, the control setpoint 442 may be dependent on minimizing average dimensional error based on the measured TEI, which may be variable depending on power of the laser 106 used, properties of the experimental lines printed, etc. In some examples, users may wish to use a different average dimensional error rather than the minimum average dimensional error in selecting the control setpoint 442 based on desired factors and results.

FIG. 5 depicts a method 500 for implementing a feedback control algorithm, according to one or more embodiments of the present disclosure. The method 500 may be used for implementing the feedback control algorithm 440 for the system 100 and the system 300. The method 500 may be implemented by the first controller 304 of the controller 103. The method 500 may encompass multiple processes, such as an initialization process 503, a thermal sensing process 506, a PID calculation process 509, and a laser regulation process 512. At the initialization process 503, the first controller 304 may be initialized and a current time may be recorded.

The thermal sensing process 506 may be configured to begin after the initialization process 503. The sensing system 109 may be configured to measure operative TEI measurements occurring during the print process of the target object at a specified frequency (e.g., 2 kHz). Description regarding how the sensing system 109 may measure operative TEI is provided with the description associated with FIG. 1 and is not repeated here for sake of brevity. The first controller 304 may be configured to read the operative TEI measurement data from the sensing system 109. The first controller 304 may store the raw value of the operative TEI measurements in a queue of size 10. Additionally, the first controller 304 may use the raw values to calculate a moving average of the operative TEI measurements. The first controller 304 may calculate an error term (e.g., the error value 444) based on a comparison of the control setpoint 442 and the moving average of the operative TEI measurements.

The moving average may be used as the measurement feedback for the PID calculation process 509 because the sensor data capturing by the sensing system 109 and the PID calculations may not stop when the laser 106 turns off between two adjacent but disconnected melt tracks. This phenomenon may cause a drop of the operative TEI being measured, which may mislead the PID calculation, and lead to the laser 106 increasing its power incorrectly. To mitigate this potential issue, a moving average of the operative TEI measurements is determined to smooth corresponding data signals and remove unwanted operative TEI measurement drops. The moving average window size may be a tradeoff between the settling time of the first controller 304 and the steady state control oscillation. The moving average window size may be determined by experimental testing. For example, an ideal window size may be when the TEI fluctuation due to the laser 106 being idle is less than 5.5 TEI units (1% of the target TEI). The resulting moving average window size may be ten.

At the PID calculation process 509, a P-term, an I-term, and a D-term may be calculated based on the error value 444. For example, since the sensing system 109 senses temperature at discrete time steps, the integrals derivatives may be calculated numerically. For example, to calculate the integral or the I-term, the error value 444 may be multiplied by the frame time (0.5 ms for 2 KHz control). The resulting product may be added to a variable, which may eventually be multiplied by the integral coefficient Kᵢ. This variable may be kept and updated for each control loop.

For the D-term calculation a previous error value 444 corresponding to a previous control loop may be extracted and used to compare with a current error value 444 to calculate an error difference. This difference may be divided by 0.5 ms time laps to complete the derivative calculation. Additionally, the D-term may be calculated based on the derivative coefficient Kₐ. The P-term calculation may also be performed by multiplying the current error value 444 to a proportional coefficient Kₚ. After the current PID loop is completed, the current error value 444 may be stored as the previous error value 444 and used in the next control loop. For the PID calculation process 509, each P, I, and D calculation may have a limiter function to prevent extreme adjustments. The PID calculation process 509 may output a control signal (e.g., the control signal 448), which may be fed to the laser regulation process 512.

At the laser regulation process 512, a laser power to be applied to the laser 106 may be calculated based on receipt of the control signal 448. As a safety feature, the output laser power may also equipped with a limiter function that prevents extreme laser power during the PID tuning process 509. For example, the laser power limiter function may also restrict the laser power of the laser 106 from going below 100 W or above 500 W, which may be the minimum and the maximum laser output defined by the manufacturer. Additionally, a user may define a minimum and a maximum laser power to be applied for the print of the target object. The laser 106 may be configured to adaptively adjust its laser power based on the laser power calculated at the laser regulation process 512.

After the laser regulation process 512, the method 500 may revert back to the initialization process 503, and the processes described above may repeat to continuously determine the laser power of the laser 106 for the print process of the target object.

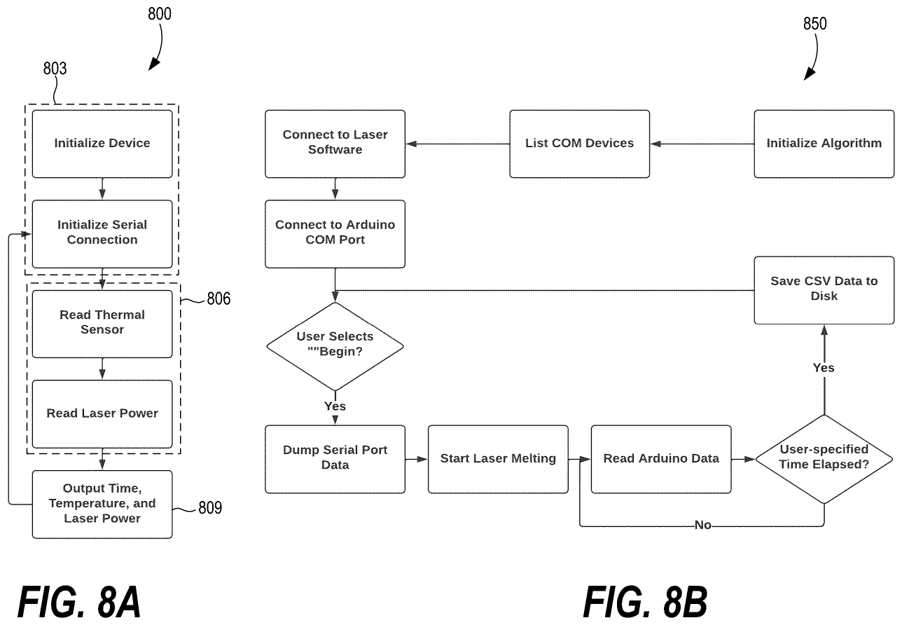

FIG. 8A depicts a method 800 for implementing a monitoring program, according to one or more embodiments of the present disclosure. The second controller 305 may be configured to implement the method 800. The second controller may execute the method 800 to monitor the feedback control algorithm implemented by the method 500 without intrusion. At step 803, the second controller 305 may be initialized and a serial connection may be established to the computer 370. At step 806, the second controller 305 may be configured to read thermal sensor data (e.g., operative TEI measurements) from the sensing system 109 for the print process of the target object. At step 806, the second controller 305 may further be configured to read laser power data calculated from the laser regulation process 512. At step 809, the second controller 305 may be configured to correlate the readings described above with time stamps and output the time-stamped readings to the computer 370 via a serial port.

FIG. 8B depicts a method 850 for implementing a data collection algorithm, according to one or more embodiments of the present disclosure. The second controller 305 may be configured to implement the method 850. The method 850 may be written in various languages including C#. The method 850 may correspond to collecting data associated with execution of the feedback control algorithm 440 and the method 500 for a user-specified time frame. The method 850 may begin with initializing the data collection algorithm via a graphic user interface (GUI) that enables a user to specify the COM port number, baud rate, and sensing duration. The baud rate may be set to 500,000 in an example. Next a list of communication (COM) devices used in implementing the feedback control algorithm 440 and the method 500 may be determined. Next, the method 850 may include connecting the data collection algorithm to the laser control software and the data logging software stored in the computer 370 via a TCP web socket. Next, the method 850 may include connecting the data collection algorithm to a communication port (e.g., Arduino® communication port) based on user selections. Next, a “Begin” button may be selected by the user to initiate the data collection algorithm to collect data associated with the feedback control algorithm 440 and the method 500. Next, a serial port internal buffer may be emptied upon beginning a data collection process. Next, the laser 106 may begin a print process for the print of the target object in connection with the feedback control algorithm 440 and the method 500. Next, the method 850 may save the data collected in the one or more memories of the computer 370 as a CSV file or other applicable file formats.

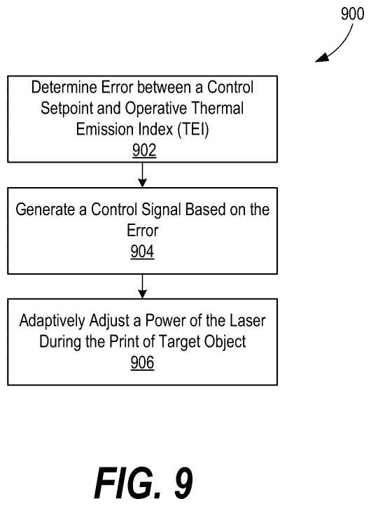

FIG. 9 depicts a method 900 for implementing a feedback control algorithm, according to one or more embodiments of the present disclosure. The controller 103 may be configured to implement and execute the method 900 for feedback control of the systems 100 and 300, for adaptively regulating a power of the laser 106 during print of a target object on the powder bed 150. Accordingly, the method 900 may be used to implement the feedback control algorithm 440 and similar to the method 500.

At step 902, the controller 103 may be configured to determine an error based on a comparison between a control setpoint and an operative TEI measured by the sensing system 109 during print of a target object by the laser 106 on the powder bed 150. For example, the control setpoint (e.g., the control setpoint 442) may be determined as described with respect to the feedback control algorithm 440 in FIG. 4. Additionally, the control setpoint 442 may correspond to a minimum dimensional error tolerated for printing the target object based on properties of the experimental lines printed with the laser 106, as explained with respect to FIGS. 6 and 7. The operative TEI may be received from the sensing system 109 and may include measurements of heat emanating from the powder bed 150 during the print of the target object. The controller 103 may implement a PID control loop (e.g., the feedback control algorithm 440) to continuously compare the operative TEI measurements with the control setpoint 442 to determine the error value 444. In various examples, the controller 103 may compare the control setpoint 442 to a moving average of the operative TEI measurements received from the sensing system 109.

At step 904, the controller 103 may further be configured to perform the PID calculations 446 with respect to the error value 444 to determine and generate a control signal 448. The control signal 448 may include calculations of laser power (e.g., variable wattage) for the laser 106 to output during the course of the print process. The controller 103 may be configured to perform continuous loops of the PID calculations 446 with respect to real-time operative TEI measurements received from the sensing device 109, so that the operative TEI measurements are maintained as close as possible to the control setpoint 442. For example, the heat originating from the powder bed 150 may be variable during the print process before application of the method 900 (and the other feedback control algorithms described herein) depending on complexity of the target object being printed, printing feature size, power of the laser 106 being used (e.g., 100 W, 200 W, 300 W, 400 W, etc.), and length of raster lines, among others.

At step 906, the controller 103 may be configured to adjust a power of the laser 106 during the print of the target object. For example, based on the continuous calculations being performed in real-time as described above with respect to step 904, the controller 103 may adaptively adjust the power of the laser 106 in real-time so that the heat originating from the powder bed 150 is maintained as close as possible to the control setpoint 442. Thus, the control setpoint 442 may correspond to a target TEI to be maintained for the print of the target object.

The embodiments described herein provide low-cost and high-speed control systems, which enable adaptive power control in real-time for a print process with L-PBF. The feedback control algorithm 440 and the method 500, for example, applicable in the systems 100 and 300, may enable adaptive power control of the laser 106 in real-time during a print process of a target object. Implementation of the feedback control algorithm 440 and the method 500 may minimize dimensional errors of target objects to be printed in a L-PBF process as compared to target objects printed with a constant laser power. The embodiments described herein provide solutions to the printing quality issues found in L-PBF processes caused by constant printing parameters. Additionally, the controller 103 may cost less than $50 to manufacture and may work independently without a computer, allowing excellent reproducibility on most if not all L-PBF machines for product quality assurance.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims. If a component is described as having “one or more” of the component, it is understood that the component can be referred to as “at least one” component.

The terms “first,” “second,” etc. are used only as labels, rather than a limitation for a number of the objects. It is understood that if multiple components are shown, the components may be referred to as a “first” component, a “second” component, and so forth, to the extent applicable.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

The flowchart of FIGS. 5, 8, and 9 are the functionality and operation of an implementation of portions of an application executed by processing circuitry or at least one hardware processor, such as in the controller 103. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor (e.g., a hardware processor) in a computer system or other system. The machine code may be converted from the source code, etc. If embodied in hardware, each block may represent a circuit or a number of interconnected circuits to implement the specified logical function(s).

Although the flowchart of FIGS. 5, 8, and 9 show a specific order of execution, it is understood that the order of execution may differ from that which is depicted. For example, the order of execution of two or more blocks may be scrambled relative to the order shown. Also, two or more blocks shown in succession in FIGS. 5, 8, and 9 may be executed concurrently or with partial concurrence. Further, in some embodiments, one or more of the blocks shown in FIGS. 5, 8, and 9 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A feedback control system, comprising:
a laser powder bed fusion (L-PBF) platform comprising a laser, the L-BPF platform configured to print a target object with the laser;
a sensing system configured to measure an operative thermal emission index (TEI) emitted during print of the target object by the L-PBF platform; and
a controller communicatively coupled to the sensing system and configured to:
determine an error based on a comparison between a control setpoint and the operative TEI;
generate a control signal based on the error; and
adaptively adjust a power of the laser during the print of the target object based on the control signal to maintain the control setpoint.

2. The feedback control system of claim 1, wherein the controller is further configured to determine the error based on a comparison of the control setpoint to a moving average of the operative TEI.

3. The feedback control system of claim 1, wherein the control setpoint corresponds to a target TEI to be maintained for the print of the target object.

4. The feedback control system of claim 1, wherein the controller is further configured to determine the control setpoint based on a calculation of an average dimensional error and a calculation of an average TEI corresponding to a plurality of experimental lines printed with the laser.

5. The feedback control system of claim 4, wherein the average dimensional error is calculated based on a comparison of the printed experimental lines to one or more computer aided design (CAD) models corresponding to the plurality of experimental lines.

6. The feedback control system of claim 4, wherein the control setpoint corresponds to a minimum dimensional error tolerated for printing the target object, the minimum dimensional error being determined based on a correlation between the average dimensional error and the average TEI.

7. The feedback control system of claim 4, wherein the plurality of experimental lines are printed with a plurality of different powers of the laser.

8. The feedback control system of claim 1, wherein the laser comprises a minimum printing power and a maximum printing power, the minimum printing power corresponding to approximately 100 W and the maximum printing power corresponding to approximately 500 W.

9. The feedback control system of claim 1, wherein the sensing system comprises a photodetector and a variable resistor electrically coupled to the photodetector.

10. The feedback control system of claim 9, wherein:
the photodetector is a light-dependent resistor (LDR) configured to detect the operative TEI from a powder bed during the print of the target object; and
the variable resistor is a potentiometer configurable to adjust a sensitivity range of the LDR.

11. The feedback control system of claim 1, wherein:
the controller comprises a proportional-integral-derivative (PID) controller; and
the controller is further configured to generate the control signal based on processing the error with a proportional (P) calculation, an integral (I) calculation, and a derivative (D) calculation.

12. The feedback control system of claim 11, wherein the controller comprises a first controller and a second controller, the first controller comprising the PID controller and the second controller comprising a data acquisition controller.

13. The feedback control system of claim 1, wherein the controller comprises an Arduino® based controller.

14. A method for controlling a system, the system comprising a laser powder bed fusion (L-PBF) platform and a sensing system, the method comprising:
determining, by a controller, an error based on a comparison between a control setpoint and an operative thermal emission index (TEI) measured by the sensing system during print of a target object by a laser of the L-PBF platform;
generating, by the controller, a control signal based on the error; and
adaptively adjusting, by the controller, a power of the laser during the print of the target object based on the control signal to maintain the control setpoint.

15. The method of claim 14, wherein determining the error further comprises comparing the control setpoint to a moving average of the operative TEI.

16. The method of claim 14, wherein the control setpoint corresponds to a target TEI to be maintained for the print of the target object.

17. The method of claim 14, wherein the control setpoint is determined based on a calculation of an average dimensional error and a calculation of an average TEI corresponding to a plurality of experimental lines printed with the laser.

18. The method of claim 14, wherein the sensing system comprises a photodetector and a variable resistor electrically coupled to the photodetector.

19. The method of claim 18, wherein:
the photodetector is a light-dependent resistor (LDR) configured to detect the operative TEI from a powder bed during the print of the target object; and
the variable resistor is a potentiometer configurable to adjust a sensitivity range of the LDR.

20. The method of claim 14, wherein the controller comprises a proportional-integral-derivative (PID) controller, and wherein generating the control signal is further based on processing the error with a proportional (P) calculation, an integral (I) calculation, and a derivative (D) calculation.
